(19) United States
(12) Patent Application Publication
(10) Pub. No.: US 2006/0023447 A1
(43) Pub. Date: Feb. 2, 2006

(54) Luminous body for generating white light

(76) Inventors: Thomas Justel, Aachen (NL); Dietrich Bertram, Aachen (DE); Peter Schmidt, Aachen (DE)

Correspondence Address: PHILIPS INTELLECTUAL PROPERTY & STANDARDS, P.O. BOX 3001, BRIARCLIFF MANOR, NY, 10510, US

(21) Appl. No.: 10/531,024

(22) PCT Filed: Oct. 8, 2003
(86) PCT No.: PCT/IB03/04415

§ 371 Date: Apr. 12, 2005

(30) Foreign Application Priority Data
Oct. 14, 2002 (DE) 10247833.3

(51) Int. Cl. G09G 3/10

(52) U.S. Cl. 362/231; 315/169.3; 313/503; 313/634

(57) ABSTRACT

A luminous body for generating white light is described which is provided with a combination of a light-emitting diode radiating blue light and a fluorescent lamp comprising green and red phosphors.

The invention relates to a luminous body for generating white light having the particular features of an enhanced useful life and a greater color point stability.

It is known that a three-color phosphor mixture is used in high-quality fluorescent lamps for the generation of white light. The color point of the lamp is then determined by the mixing ratio of the phosphors.

The blue phosphors used at present represent a particular problem here for maintaining the color point because of the sensitivity of the activator Eu²⁺. As a result, fluorescent lamps exhibit an undesirable shift in their color point during lamp operation, which is particularly unpleasant in the case of compact fluorescent lamps (energy-saving lamps).

Fluorescent lamps are known from Japanese patent application JP-10275600 A whose light spectrum can be modified by a light-emitting diode. The light-emitting diode, however, is integrated in the burner in this case, so that it comes into contact with the discharge. A gas discharge is a highly aggressive medium which would quickly destroy the light-emitting diode. In addition, the complete omission of the blue phosphor, which has always been used until now, is not proposed therein.

It is accordingly an object to develop luminous bodies which are remarkable for a long useful life and an improved color point stability.

This object is achieved by means of a luminous body which, for the purpose of generating white light, is provided with a combination of light-emitting diodes generating blue light (380-500 nm) and one or several fluorescent lamps comprising green and red phosphors. The fluorescent lamps emit a yellowish-white light with a color temperature of between 2500 and 3000 K owing to the absence of the blue emission.

The light-emitting diodes providing blue light may be arranged in the luminous body according to the invention in various manners, as long as a good light mixing and a homogeneous light are achieved thereby. However, they cannot be directly integrated into the burner of a fluorescent lamp, since the contact with the discharge would considerably reduce their useful lives.

Since the useful life of the blue light-emitting diode is much longer than that of conventional gas discharge sources, the useful life and the color point stability of the luminous body are considerably enhanced by the invention.

The short life of conventional luminous bodies is mainly due to the blue light-emitting phosphors containing Eu²⁺ such as BaMgAl₁₀O₁₇:Eu and Sr₅(PO₄)₃(F,Cl):Eu. These phosphors have a comparatively fast depreciation and have given rise to numerous experiments aimed at improving the quality of the phosphors so as to avoid their fast depreciation. Alternative phosphors for replacing these blue light-emitting substances, however, have not been found until now.

The emission of blue light is a decisive element in a luminous body radiating white light, in particular at high color temperatures. Since the phosphor radiating blue light forms the weak spot of all fluorescent lamps (TL, PL and CFL) used at present, the solution according to the invention considerably reduces this problem of lamp life for these lamps, which is of essential importance for the economy of such lamps.

The luminous body according to the invention is preferably formed by a combination of a conventional fluorescent lamp provided with red and green phosphors and an InGaN or AlInGaV light-emitting diode providing blue light in a wavelength range of between 380 and 500 nm. The two light sources, i.e. the fluorescent lamp(s) and the blue light-emitting diodes, are accommodated in a single lamp housing or in the same luminaire.

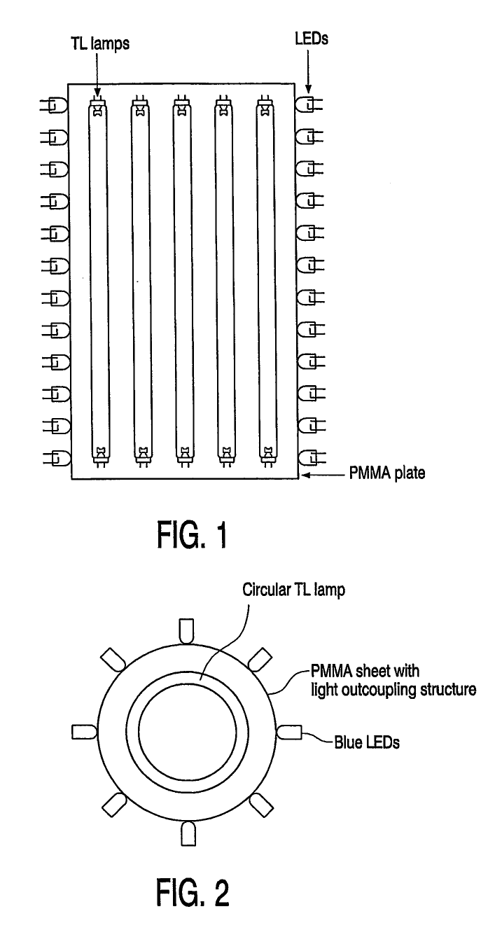

The invention will be clarified with reference to the drawing comprising FIGS. 10, 1 to 6, in which

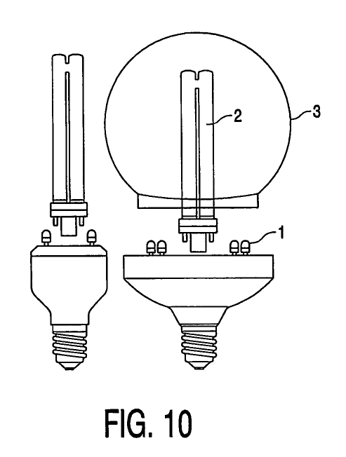

FIG. 10 shows a lamp according to the invention with light-emitting diodes providing blue light,

FIG. 1 shows a rectangular light tile with light-emitting diodes providing blue light and with fluorescent tubular lamps,

FIG. 2 shows a round light tile with light-emitting diodes providing blue light and a circular tubular fluorescent lamp,

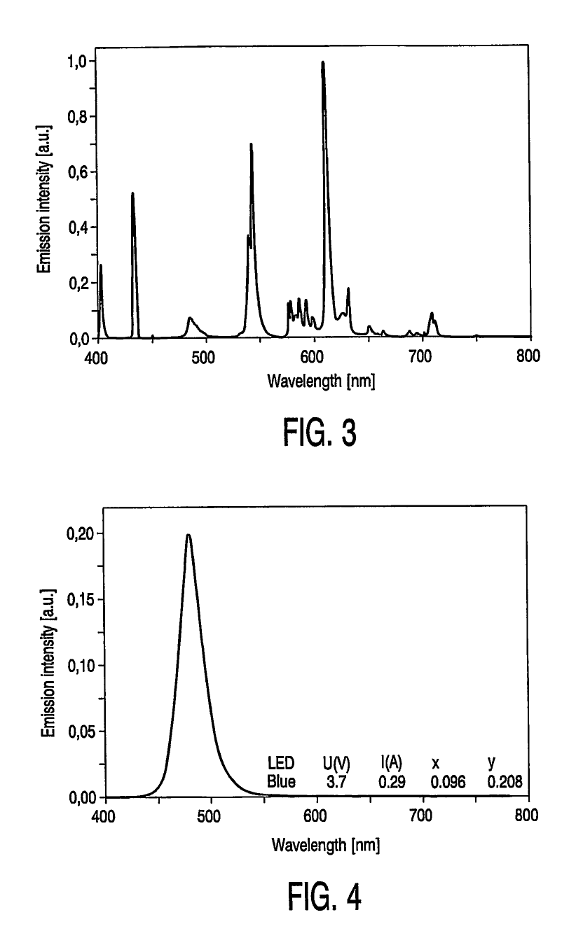

FIG. 3 shows the emission spectrum of a fluorescent lamp with LaMgAl₁₁O₁₉:CeTb and Y₂O₃:Eu,

FIG. 4 shows the emission spectrum of a light-emitting diode that radiates blue light,

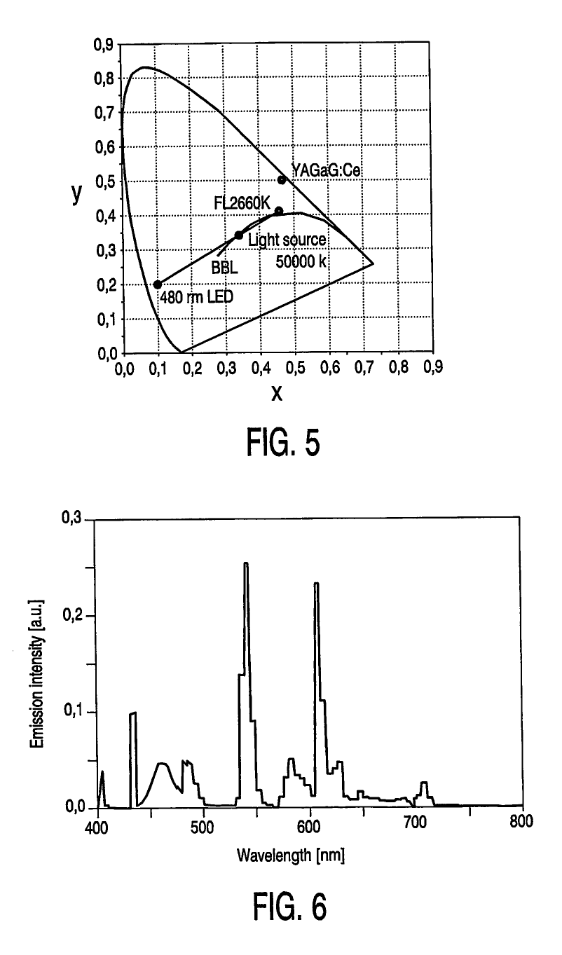

FIG. 5 shows the color points of a light-emitting diode that radiates blue light, a fluorescent lamp, and the light source formed by the former two at 5000 K CCT, and FIG. 6 shows the emission spectrum of a luminous body combining light-emitting diodes radiating blue light and fluorescent lamps provided with LaMgAl₁₁O₁₉:CeTb and Y₂O₃:Eu, at 5000 K CCT.

FIG. 10 shows a luminous body according to the invention with the light-emitting diodes 1 radiating blue light, the fluorescent lamp 2, and the outer lamp bulb which is coated with a light-scattering layer. It is possible here, for example, for three InGaN light-emitting diodes radiating blue light with an emission maximum of 480 nm to be accommodated inside the outer lamp bulb 3. The fluorescent lamp is coated with LaMgAl₁₁O₁₉:CeTb (green) and Y₂O₃:Eu (red), such that a yellowish-white light is generated if the fluorescent lamp is operated alone. The current supply to the light-emitting diodes is integrated into the base of the luminous body. When the light-emitting diodes are switched on together with the fluorescent lamp, the light will be mixed inside the lamp bulb and the overall radiated light will appear white, which corresponds to a color temperature T_{c}=5000 K. An increase in the current through the light-emitting diodes leads to an increased radiation of blue light, which causes the color temperature of the overall radiated light to rise; a reduction in the current reduces the quantity of blue light and accordingly lowers the color temperature of the emitted light.

The color rendering index achieved in this manner lies above 80 for all color temperatures between 2600 and 10,000 K.

The luminous bodies according to the invention as shown in FIGS. 1 and 2 have planar or circular shapes which are covered with PMMA plates. The fluorescent lamps comprise a green phosphor, for example LaPO₄:CeTb, LaMgAl₁₁O₁₉:CeTb, or GdMgB₅O₁₀:CeTb, and, for example, Y₂O₃:Eu or Y(V,P)O₄:Eu as the red phosphor.

FIG. 3 shows the emission spectrum of such a fluorescent lamp. The color points of these fluorescent lamps (x=0.47, y=0.42) lie close to the color point of YAGaG:Ce (x=0.48, y=0.50) used in light-emitting diodes that radiate white light (see FIG. 5).

An increase in the current strength renders it possible to raise the color temperature of the blue light-emitting diodes up to 10,000 K, with the result that the color point lies close to the blackbody locus for this color temperature, provided the blue light-emitting diode was correctly chosen. Most suitable are blue light-emitting diodes with a color point at x=0.1 and y=0.2.

The advantages of the luminous body according to the invention lie in an improved luminous efficacy and a higher color point stability, because the useful life of the light-emitting diode is much longer than the useful life of a conventional blue phosphor as used until now in fluorescent lamps.

In addition, the light color can be modified more easily in the luminous body according to the invention in that simply the radiation of the blue light of the light-emitting diode is varied through an increase or decrease in the current strength. It is necessary for this that a separate current supply is provided for the light-emitting diode, so that the current flow to the light-emitting diode, and thus its light emission, can be controlled independently of the light emission of the fluorescent lamp. This renders it possible to adjust the color temperature of the blue light-emitting diode over a wide range, for example between 2660 K and 10,000 K.

The combination of two light sources which should appear to be only a single one necessitates certain optical means for mixing the light in a suitable manner. In their absence the light combination would be visible and the radiated light would appear to be inhomogeneous. It is accordingly necessary to integrate the light-emitting diodes into the lamp such that a good light distribution and mixing are safeguarded.

This may be readily achieved in GLS-look-alike CFL-I lamps because an outer thermoplastic bulb has already been developed for these, which bulb scatters the light by means of a powder layer. The blue light-emitting diodes then merely have to be accommodated inside the outer bulb of the CFL-I lamp, while the necessary electronic control means can be accommodated in the lamp base. Alternative constructions for implementing the present invention are also conceivable, for example accommodating the blue light-emitting diode inside the same lamp housing, or alternatively in a lamp housing separate from the fluorescent lamp. The light-emitting diode may also be used in conjunction with a PMMA plastic foil or plastic plate which is covered with a light-scattering layer at one side and with a structure for coupling out the light on the other side.

A compact fluorescent lamp, a Hg low-pressure gas discharge lamp, a Hg high-pressure gas discharge lamp, or a sulphur lamp may be used as the fluorescent lamp in the luminous body according to the invention. The useful life and the color point stability of the luminous body are considerably improved in the generation of white light in all cases.

1. A luminous body for generating white light, characterized in that it is provided with a combination of light-emitting diodes radiating blue light and a fluorescent lamp comprising green and red phosphors.

2. A luminous body as claimed in claim 1, characterized in that the light-emitting diode radiating blue light comprises a semiconductor based on InGaN or AlInGaN.

3. A luminous body as claimed in claims 1 and 2, characterized in that the blue light radiated by the light-emitting diode lies in a wavelength range of between 380 and 500 nm.

4. A luminous body as claimed in claims 1 to 3, characterized in that the fluorescent lamp is a compact fluorescent lamp (energy-saving lamp), a Hg low-pressure gas discharge lamp (fluorescent tube), a Hg high-pressure gas discharge lamp, or a sulphur lamp.

5. A luminous body as claimed in claims 1 to 4, characterized in that the fluorescent lamp comprises at least one phosphor from the group of LaPO₄:CeTb, LaMgAl₁₁O₁₉:CeTb, GdMgB₅O₁₀:CeTb, Y₂O₃:Eu, Y(V,P)O₄:Eu, or one of the mixtures thereof.

6. A luminous body as claimed in claims 1 to 5, characterized in that the light-emitting diode radiating blue light is accommodated inside the same lamp housing as the fluorescent lamp.

7. A luminous body as claimed in claims 1 to 8, characterized in that the light-emitting diode radiating blue light is accommodated in a lamp housing separate from the fluorescent lamp.

8. A luminous body as claimed in claims 1 to 7, characterized in that a separate current supply is provided for the light-emitting diode radiating blue light, such that the current flow to the light-emitting diode and thus its light emission can be controlled independently of the light emission of the fluorescent lamp.
